(19) United States
(12) Patent Application Publication
(10) Pub. No.: US 2015/0350731 A1
(43) Pub. Date: Dec. 3, 2015

(54) PROCESSING OF A FIRST BROADCAST DATA STREAM, CODING A FIRST AUDIOVISUAL CONTENT ASSOCIATED WITH A SECOND AUDIOVISUAL CONTENT

(71) Applicant: ORANGE, Paris (FR)

(72) Inventors: Chantal Guionnet, Cesson Sevigne (FR); Pierre Fevrier, St Sulpice La Foret (FR); Nathalie Bacher, Chantepie (FR)

(21) Appl. No.: 14/654,816

(22) PCT Filed: Dec. 23, 2013
(86) PCT No.: PCT/FR2013/053244

§ 371 Date: Jun. 22, 2015

(30) Foreign Application Priority Data
Jan. 3, 2013 (FR) 1350019

(51) Int. Cl. H04N 21/472; H04N 21/422; H04N 21/433; H04N 21/858

(52) U.S. Cl. CPC H04N 21/472; H04N 21/858; H04N 21/422; H04N 21/433

(57) ABSTRACT

The invention relates to a method of processing a first data stream broadcast by a broadcasting network to a terminal device of a user and undergoing playback by said terminal device, said first data stream coding a first audiovisual content and comprising at least one identifier of said first audiovisual content, characterized in that said first audiovisual content being associated with at least one second audiovisual content, coded in a second data stream, the broadcasting of which is envisaged, said method comprising the following steps: detection (T1) during the playback of said first stream, of a user interaction representative of a predetermined action command on said at least one second stream; obtaining (T3) of an identifier of said at least one second audiovisual content on the basis of the identifier of the first audiovisual content; obtaining (T5) of temporal information associated with said identifier of second content; programming (T7) of the action commanded at least with the aid of the identifier of second content and of the temporal information obtained, said action being intended to be triggered in conjunction with the broadcasting of the second stream.

### 1. FIELD OF THE INVENTION

The field of the invention is that of telecommunications, and more particularly the broadcast of audiovisual streams to access terminals via a broadcast network.

It applies in particular to actions commanded by a user of an access terminal (“set-top-box”), for example with the aid of a remote control, on a content being broadcast.

### 2. DESCRIPTION OF THE PRIOR ART

Today, an audiovisual content broadcast in real time can be recorded in two ways:
ahead of time, by looking up the paper or electronic program guide and performing a manual or automatic programming of the record operation;
while viewing the audiovisual content, by instantaneous request taking the form of a simple push on a particular key of a user remote control, for example dedicated to recording.

### 3. DRAWBACKS OF THE PRIOR ART

It is not possible to instantly program the recording of an upcoming broadcast of an audiovisual content while a content trailer is being broadcast.

### 4. OBJECTIVES OF THE INVENTION

It is notably an object of the invention to overcome these drawbacks of the prior art.

More specifically, an object of the invention is to simplify the programming of a recording of an upcoming broadcast of an audiovisual content, while viewing a trailer of this content.

More generally, an objective of the invention is to provide for commanding the programming of a future action on a second audiovisual content, which is planned to be broadcast, while a first content exhibiting an explicit link with this second content is being broadcast.

### 5. DESCRIPTION OF THE INVENTION

These objectives, and others which will emerge later, are achieved with the aid of a method for processing a first data stream being broadcast over a telecommunications network to an access terminal of a user and being restored to said user by said terminal, said first data stream encoding a first audiovisual content associated with a second audiovisual content, a second data stream encoding said second audiovisual content being planned to be broadcast. The method according to the invention is particular in that it comprises the following steps:
detecting, during the restoration of said first stream, of a user interaction representative of a command of predetermined action on said at least one second stream;
obtaining of an identifier of said at least one second audiovisual content from the identifier of the first audiovisual content;
obtaining of time-related information associated with said second content identifier;
programming of the commanded action at least with the aid of the second content identifier and the time-related information obtained, said action being intended to be triggered in connection with the broadcast of said second stream.

With the invention, a user can program a predetermined action on an audiovisual content, of which the user views for example a trailer, in an impulsive manner and without interrupting the current viewing. The predetermined action can be, for example, a record operation, an automatic zapping request, or any other simple action, that can be performed by an access terminal in connection with this audiovisual content which the user wishes to view. Advantageously, this predetermined action is associated with a specific key of a remote control of the user.

The invention thus proposes a completely novel and inventive approach for the interaction by a user with a broadcast content, based on the principle of indirection between broadcast content items. The action commanded by the user does not directly target the first stream being broadcast, but indirectly the second stream which is associated with it and which is due to be broadcast.

The association between the first and second content items must of course be sufficiently explicit during the broadcast of the first content in order to arouse the desire of the user to immediately program an action on this second content, before it is broadcast.

According to another aspect of the invention, the identifier of said at least one second content is obtained by looking up a description element of the first audiovisual content of an event information table contained in the first broadcast stream, said element containing the identifier of the second audiovisual content in a first information field of said element.

The table EIT of the first stream is enriched at least with a data field associated with the first audiovisual content and which contains an identifier of the second audiovisual content affected by the user interaction. An advantage of this embodiment is that the access terminal does not necessarily need to look up the program guide. It obtains the information that it needs directly from the first data stream.

According to one aspect of the invention, said identifier of the second content is obtained by looking up a description element of the first audiovisual content contained in a program guide, the identifier of the second audiovisual content being inserted in an information field of said element.

An advantage of this embodiment is that it does not have an impact on the size of the data stream encoding the first audiovisual content, the identifier of the second content being inserted in the description element of the first audiovisual content of the program guide.

According to yet another aspect of the invention, said time-related information is obtained by looking up the description element of the first audiovisual content of the event information table contained in the first broadcast stream, said element containing said time-related information in a second information field of said element.

An advantage of this embodiment is that the set of metadata necessary to program the action commanded by the user is available in the first data stream.

According to yet another aspect of the invention, said time-related information is obtained by looking up the description element of the second stream in the program guide.

An advantage of this embodiment is that the event table of the data stream is not too loaded, the time-related information relating to the broadcast of the second content being inserted in the program guide.

According to another aspect of the invention, the lookup step is repeated at regular intervals until said information is found in the program guide.

If the broadcast of the second content is not scheduled in the program guide to which the terminal has access, the invention provides for renewing the lookup later on an updated version of the program guide.

The invention relates also to a device for processing a data stream encoding a first audiovisual content suitable for implementing the processing method which has just been described, in its various embodiments.

The invention relates also to an access terminal for accessing a data stream broadcast network, including such a processing device.

The invention relates also to a method for broadcasting an audiovisual data stream intended to be broadcast via a broadcast network and restored to a user by an access terminal, said stream encoding a first audiovisual content and containing at least one identifier of said first audiovisual content. According to the invention, such a method is particular in that it comprises a step for inserting in said data stream an identifier of at least one second audiovisual content associated with said first audiovisual content, a second data stream encoding said at least one second content being planned to be broadcast via the broadcast network.

An advantage of this aspect of the invention is that it allows the access terminal to identify directly from the first stream the second content to which the action commanded by the user relates, while the first content is being broadcast.

The invention further relates to a broadcast device suitable for implementing the method which has just been described.

The invention relates also to server equipment comprising such a broadcast device.

The invention relates also to a telecommunications signal carrying a first audiovisual data stream intended to be broadcast via a broadcast network and restored to a user by an access terminal, said first stream encoding a first audiovisual content and containing at least one identifier of said first audiovisual content. According to the invention, such a signal is particular in that it additionally contains at least one identifier of a second audiovisual content associated with said first audiovisual content, a second stream encoding said second audiovisual content being planned to be broadcast, said identifier being implemented by the processing method which has just been described.

Advantageously, said signal additionally contains time-related information associated with said second content identifier, said time-related information being implemented by the processing method which has just been described.

The invention relates also to a system for broadcasting data streams encoding audiovisual content items. Such a system is particular in that it comprises server equipment according to the invention, at least one access terminal according to the invention and a broadcast network suitable for broadcasting said streams between said server equipment and said at least one access terminal.

The invention further relates to a computer program including instructions for implementing the steps of a processing method as described previously, when this program is executed by a processor. Such a program can use any programming language. It can be downloaded from a communication network and/or saved on a computer-readable medium.

The invention relates also to a storage medium, readable by a processor, integrated or not integrated with the processing device according to the invention, possibly removable, storing a computer program implementing a processing method as described previously.

The invention relates also to a computer program including instructions for implementing the steps of a broadcast method as described previously, when this program is executed by a processor. Such a program can use any programming language. It can be downloaded from a communication network and/or saved on a computer-readable medium.

Other objectives of the invention are recording media or data media readable by a computer and including computer program instructions as mentioned above.

The abovementioned recording media can be any entity or device capable of storing the program. For example, the media can include a means of storage such as a ROM, for example a CD-ROM or a microelectronic circuit ROM, or a magnetic recording means, for example a floppy disk or a hard disk.

On the other hand, the recording media can correspond to a transmittable medium such as an electrical or optical signal, which can be conveyed via an electrical or optical cable, via radio or via other means. The programs according to the invention can be in particular downloaded over an Internet type network.

### 6. LIST OF FIGURES

Other advantages and features of the invention will become clearer upon reading the following description of a particular embodiment of the invention, which embodiment is given by way of simple illustrative and nonlimiting example, and from the appended drawings in which:

FIG. 1 schematically presents a system for broadcasting an audiovisual signal according to the invention;

FIG. 2 illustrates an example program guide according to the invention;

FIGS. 3a to 3c schematically illustrate the structure of a signal carrying a first audiovisual data stream according to three embodiments of the invention;

FIG. 4 schematically presents the steps of a method for processing a first audiovisual stream according to the invention;

FIG. 5 schematically presents the steps of a method for broadcasting a first audiovisual stream according to the invention;

FIG. 6 presents the simplified structure of a device for processing a first audiovisual stream according to one embodiment of the invention;

FIG. 7 presents the simplified structure of a device for broadcasting a first audiovisual stream according to one embodiment of the invention;

FIG. 8 illustrates an example usage scenario of the invention; and

FIG. 9 illustrates a second example usage scenario of the invention.

### 7. DESCRIPTION OF A PARTICULAR EMBODIMENT OF THE INVENTION

The general principle of the invention relies on the association with an identifier of the first audiovisual content being broadcast, of an identifier of a second audiovisual content, for which the stream is planned to be broadcast later. This association allows a user to indirectly command, while viewing the first content, an action on the second content in connection with its planned broadcast, as easily as if the user were commanding an action on the first content being broadcast.

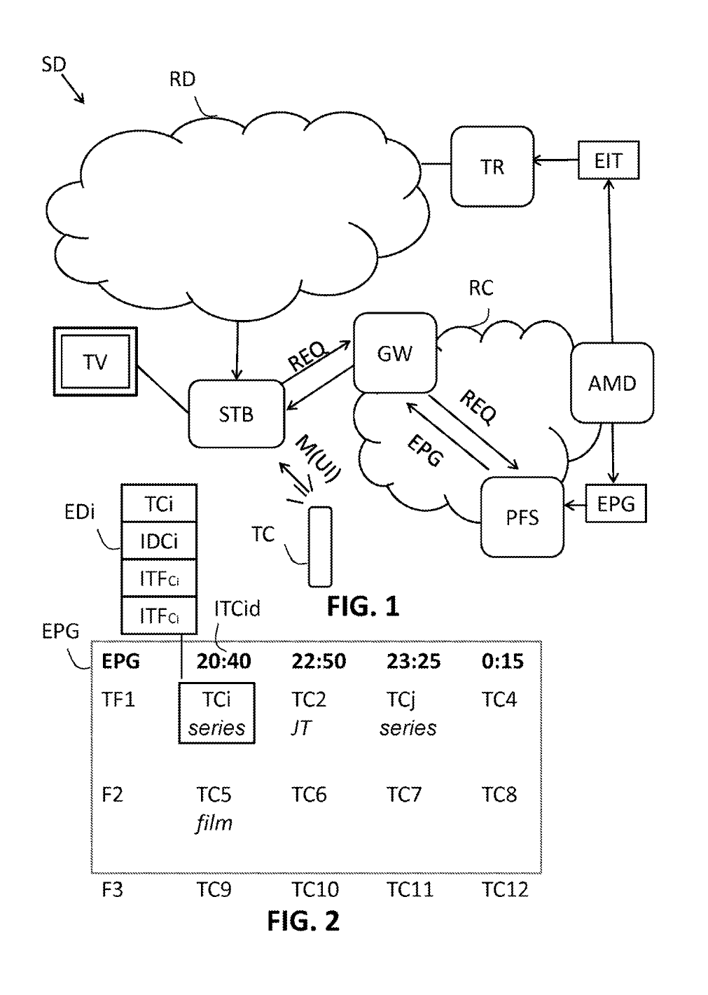

With reference to FIG. 1, there is presented a system SD for broadcasting data streams encoding audiovisual content items broadcast by a headend TR. In a known way, such streams are broadcast, by way of example, via radio, satellite or multicast IP links, in accordance with a digital television standard, such as for example the DVB (“Digital Video Broadcasting”) standard. The system includes an access terminal STB for accessing such streams, suitable for receiving them, processing them and restoring them to a user. This access terminal comprises, or depending on the cases, is connected to a restoration terminal, for example a television set TV. The access terminal STB is also equipped with means for storing audiovisual content, notably content which is broadcast via the network RD. Alternatively, it can also be connected to an external audiovisual content recording module.

The user can interact with the access terminal STB with the aid of a remote control TC having keys dedicated to pre-recorded commands. For example, the user can request the recording of a content while it is being broadcast, via a simple push of the “record” key. The user can also change channel by pressing the “P+” or “P-” keys. When the user operates a key, on his/her remote control, a message containing the command associated with this key is sent to the access terminal STB according to a known and standardized communication protocol, for example a protocol for an infrared remote control of type RC5 (“Remote Control 5”), which will not be detailed here.

Alternatively, an intelligent terminal (“smartphone”) or a tablet equipped with a suitable software application, can advantageously replace the physical remote control. For example, the intelligent terminal communicates with a remote server which sends a command message corresponding to the action chosen by the user by means of the remote control application at the access terminal STB.

Optionally, the access terminal STB comprises means of connection to a telecommunications network RT, such as for example the Internet network, thereby allowing it to exchange information with a service platform PFS. In a known way, the means of connection to the network RT can be, for example, of the xDSL, fiber or 3G type.

By means of this connection, the access terminal STB can request a program guide EPG (“Electronic Program Guide”) containing information relating to the broadcasts scheduled by the headend TR, such as an identifier of the content in question, the title of this content, the content type and time-related information such as broadcast date, start time and end time. The terminal STB is arranged to process the EPG information obtained and to intelligibly restore to the user the information that is of interest to him/her. Generally, the program guide thus obtained provides for displaying programs over a period of 14 days.

It will be noted that the program guide can also be reconstructed by the access terminal STB purely from signaling information conveyed in the data stream. In that case, the connection to the network RT is not necessary.

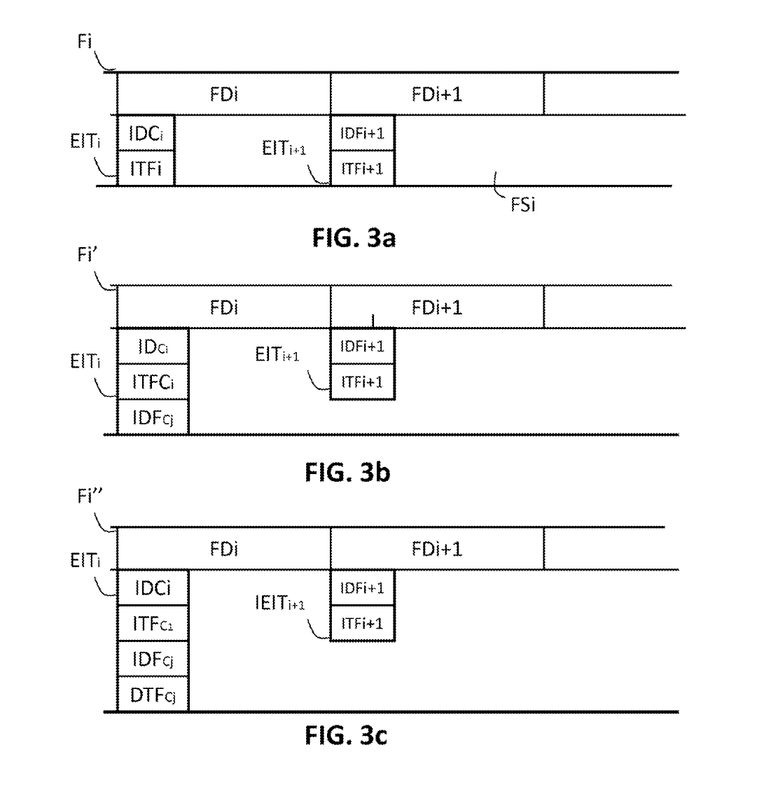

These aspects will be described further in detail with reference to FIGS. 3a to 3c.

With reference to FIG. 2, there is represented an example program guide EPG, as restored to the user. In this example, the guide displayed presents the schedule for the upcoming evening on various channels. The time slots are presented on the abscissa and the channels on the ordinate. In cases corresponding to a predetermined channel and time slot, information on the broadcast content can be found, for example the title of the content TCi and its type. The time-related information associated with the broadcast of this content Ci, such as the start and end times ITCi_{d}, ITCi_{f} correspond to the time slot indicated.

With reference to this content Ci, the description element EDi represented in FIG. 2, contains other information or metadata, which is relevant for the system and transmitted in the EPG but not necessarily restored to the user. An example of this is an identifier of the content IDCi. According to one aspect of the invention, the description element EDi additionally contains an identifier of a second content IDCi associated with the first content Ci.

The content Ci being broadcast is routed through the network RD in a signal S carrying a data stream, the structure of which will now be presented schematically with reference to FIGS. 3a, 3b and 3c. This stream Fi comprises a sub-stream SFDi containing the data encoding the content Ci and a signaling sub-stream SFSi, containing information enabling the processing of the stream Fi by the access terminal STB of the user.

With reference to FIG. 3a, among the information transmitted in the signaling sub-stream SFSi, the event information table EIT (“Event Information Table”) is known. This table contains a description element EITi for a data sub-stream FSi relating to a broadcast content. This description element contains at least one identifier of the content Ci, information describing the content Ci, such as for example its type, associated time-related information, broadcast start time and end time.

With reference to FIG. 3a and according to a first aspect of the invention, the first content Ci being broadcast necessarily has an associated description element EITᵢ in the signaling sub-stream, whether or not it is displayed in the program guide, and this element EITᵢ contains at least one identifier IDCᵢ of this first content.

With reference to FIG. 3b and according to a second aspect of the invention, the description element EITᵢ additionally contains an identifier of the second content Cj to which the first content Ci makes explicit reference.

Advantageously, this identifier IDCⱼ corresponds to the identifier of content Cⱼ which will be inserted in the program guide EPG when its broadcast will be scheduled and to the identifier which will be inserted in the signaling sub-stream FSⱼ associated with the data sub-stream FDⱼ when it is broadcast via the network RD. In other words, with this identifier IDCⱼ, the access terminal STB of the user can obtain supplementary information in connection with a broadcast of this second content Cⱼ.

With reference to FIG. 3c, the description element EITᵢ additionally contains supplementary information associated with the second content Cⱼ. Advantageously, this supplementary information is that needed by the access terminal to implement the action commanded by the user on the second content. This is for example time-related information such as the broadcast date, start time and end time. Thus, the access terminal STB of the user obtains in only one operation all the information which it needs to program the action commanded by the user.

The syntax of the event table EIT is specified in the DVB-SI standard, which specifies data fields, referred to as “private”, which can be used freely. The metadata according to the invention can, according to a first aspect, be inserted in a “private” field of a description element EITᵢ of the table EIT of the signaling sub-stream of a broadcast data stream. According to a second aspect, a specific field could be created for the usage provided for by the invention and specified, for example, in the DVB-SI standard. This would have the advantage of bringing about universal compatibility of commercially available access terminals.

According to the invention, these items of metadata relating to the second content Cⱼ can therefore either be inserted in the program guide EPG according to a first embodiment for example illustrated by FIG. 3a, or be inserted by the source TR of the broadcast system SD in the signaling sub-stream FS of the stream Fᵢ according to a second embodiment of the invention for example illustrated by FIG. 3c, or lastly be, for some of them, inserted in the signaling substream and, for others, inserted in the program guide according to a third embodiment for example illustrated by FIG. 3b.

With reference to FIG. 1, there is represented an item of equipment AMD responsible for metadata aggregation and connected to the telecommunications network RT. Such equipment is arranged to supply the metadata about the audiovisual content items according to the invention to the headend TR and to the service platform PFS of the broadcast system SD.

According to the first mode, it is the service platform PFS which inserts the set of these metadata items in the program guide EPG. According to the second mode, to headend TR inserts them in the data stream encoding the first content Ci. According to the third mode, the headend inserts one part of these metadata items in the stream of the first content Ci and the service platform the other part of these metadata items in the program guide EPG.

It is now considered that the user is in front of his/her television set and that he/she is viewing a first broadcast content Cᵢ. It is assumed that this content Cᵢ, at one given moment at least of its broadcast makes explicit reference to a second audiovisual content Cⱼ, which is planned to be broadcast in the more or less near future. In this example, its broadcast is scheduled to be on the same day, but later in the evening. The episode Cᵢ of the series announces the broadcast of the next episode. It can be envisaged for this broadcast to be planned on the same television channel or on another.

It is assumed that during the broadcast of the episode Cᵢ, in particular at the moment of the announcement of the next broadcast of the next episode, the user interacts with his/her remote control TC in order to transmit a command intended for his/her access terminal STB. By way of example, the interaction UI in question is a record command.

With the invention, although this interaction UI has been transmitted during the broadcast of the first content Cᵢ, it is interpreted by the access terminal as a command relating to the second content Cⱼ, to which the first content Cᵢ explicitly makes reference.

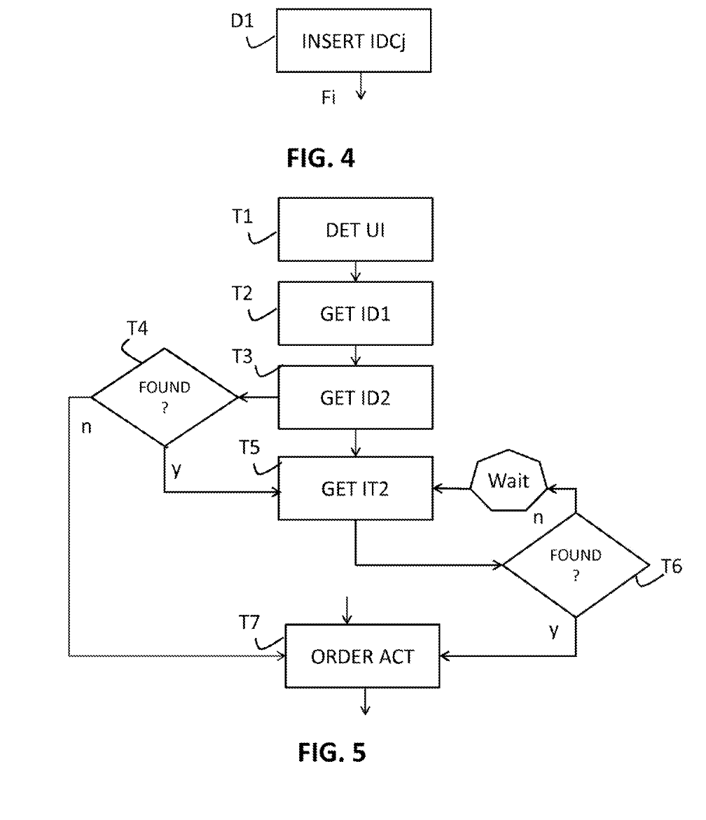

With reference to FIG. 4, the steps of the broadcast method implemented by the headend server equipment TR of FIG. 1 are now presented, according to an example embodiment of the invention, corresponding to FIG. 3b or 3c.

According to the invention, during a step D1, the server equipment TR inserts in the first data stream Fi, before its broadcast over the network RD, an identifier of the second content Cj associated with the first content Ci. Advantageously, it inserts this identifier in the signaling sub-stream SFSi, more specifically in the description element EITᵢ of the event table EIT described previously.

With reference to FIG. 5, the steps of the processing method implemented by the access terminal STB of FIG. 1 are now presented, according to an example embodiment of the invention. In this example, the user views a first content Ci being broadcast.

During a first step T1, the interaction UI of the user is detected by the access terminal STB. For example, it has received a message M(UI) containing an indication of the key pressed by the user on his/her remote control TC. This is for example the record key.

At T2, the access terminal STB obtains an identifier of the first content Cᵢ being broadcast at the moment of the interaction UI. Advantageously, it obtains it by looking up the description element EITᵢ of the signaling sub-stream SFSᵢ associated with the data sub-stream SFᵢ.

At T3, the access terminal STB obtains an identifier of a second content associated with the first content identifier IDCᵢ.

According to a first embodiment of the invention, with reference to FIG. 3a, this identifier IDCⱼ is not contained in the description element EITᵢ of the first content. The access terminal does not obtain it from the first broadcast stream, but searches for it in a program guide EPG which it has obtained in a prior step. As mentioned earlier, the access terminal has generally reconstructed this program guide EPG from information broadcast in the data stream or even transmitted by the service platform PFS.

It will be noted that if the access terminal did not have, at this stage, the program guide EPG, it could also, according to a variant embodiment, request the metadata that it needs directly from the service platform PFS, via a simple request.

This program guide EPG associates in a description element EDᵢ associated with the first content Cᵢ supplementary metadata items, including time-related information items on the broadcast event for the content Ci, which have already been described previously.

According to the invention, several cases are possible:
either these supplementary information items include an identifier IDCⱼ of an associated second content Cⱼ;
or they do not include an identifier of an associated second content Cj.

In the first case, the terminal obtains the identifier of a second content IDCⱼ associated with the first and decides at T4 to proceed to step T5 for obtaining time-related information associated with the second content Cⱼ. This time-related information ITCⱼ is directly available in the description element EDⱼ of the program guide EPG. Step T5 therefore consists in searching for this time-related information in the program guide EPG with the aid of the second content identifier.

Once this operation is accomplished, the processing continues with step T7 for programming the commanded action. This action relates to the second content. It is programmed with the aid of the time-related information obtained.

In the second case, the terminal observes at T5 that no associated second content identifier has been found and proceeds to step T7 for programming the commanded action. In the absence of an associated second content identifier, the access terminal decides, for example, that the action relates to the first content Ci and, in the example of a record command, triggers the immediate recording of the first content Ci. This solution is pertinent notably in the case in which the remote control key dedicated to the automatic record action is the same for a content being broadcast and for a content due to be broadcast. As a variant, notably for the case in which different keys are dedicated to each of the two types of automatic recording, it can be considered that the access terminal decides to not program any recording.

According to a second embodiment of the invention, with reference to FIG. 3b, the access terminal obtains the identifier of an associated second content in the description element EITᵢ of the table EIT of the stream Fᵢ. It decides at T4 to proceed to step T5 for searching for time-related information ITCⱼ associated with the identified second content.

In this embodiment of FIG. 3b, such time-related information ITCⱼ is not contained in the description element EITᵢ associated with the first content Cᵢ. Advantageously, step T5 hence consists in searching for its information in the program guide EPG. It begins by searching for the description element of the second content IDCⱼ in the program guide EPG.

According to a first aspect of the invention, the broadcast of the second content is scheduled in the program guide which the access terminal has. In this case, the latter therefore finds the description element EDⱼ containing the time-related information ITCⱼ which it needs to program the action commanded by the user. It decides at T7 to proceed to step T8 for programming this action.

In the example considered, it therefore programs the recording of the second content Cⱼ between the start time and the end time corresponding to the time-related information ITCⱼ that it has obtained.

According to a second aspect of the invention, the broadcast of the second content is not yet scheduled in the program guide EPG which the access terminal has. In this case, at T7, the processing method decides to trigger a new search in the program guide after a predetermined time period, during which the program guide will have been updated.

According to a third embodiment of the invention, with reference to FIG. 3c, the access terminal finds in the description element EITᵢ of the table EIT of the stream Fᵢ not only the identifier of an associated second content at T3, but also the time-related information ITCⱼ relating to the second content Cⱼ at T5. It decides at T6 to proceed to step T7 for programming the commanded action.

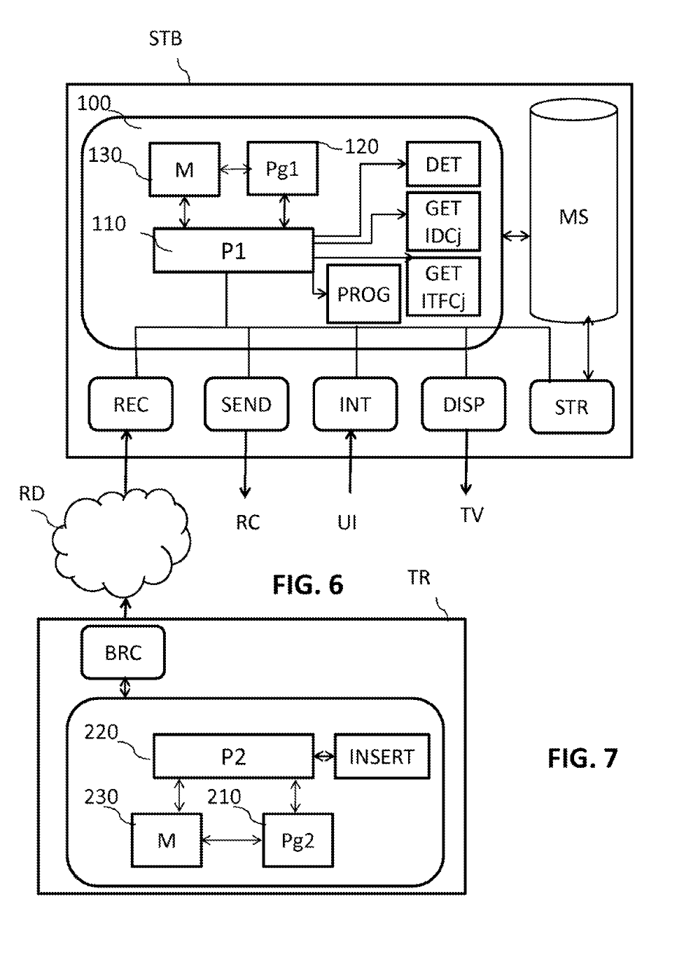

With reference to FIG. 6, the simplified structure of a device 100 for processing a first data stream according to an example embodiment of the invention is now considered. The processing device 100 implements the processing method according to the invention as described above.

In this example, the device 100 is integrated in an access terminal STB for accessing an audiovisual data stream broadcast network. According to one variant, the device 100 could be independent and connected to the access terminal STB.

For example, the device 100 comprises a processing unit 110, equipped for example with a processor P1, and driven by a computer program Pg₁ 120, stored in a memory 130 and implementing the processing method according to the invention.

Upon initialization, the code instructions of the computer program Pg₁ 120 are for example loaded into a RAM memory before being executed by the processor of the processing unit 110. The processor of the processing unit 110 implements the steps of the processing method described previously, according to the instructions of the computer program 120. According to the invention, the device 100 comprises at least one unit DET for detecting an interaction UI by a user of the access terminal STB, a unit GET for obtaining an identifier of the first broadcast content, a unit SEARCH for searching for an identifier of an associated second content and a unit ORDER for programming the commanded action. These units are driven by the processor P1 of the processing unit 110.

The processing device 100 is therefore arranged to cooperate with the access terminal STB and, in particular, the following modules of this terminal: a module INT for processing user interactions, a module REC for receiving data streams broadcast over the broadcast network RD, and a module STR for recording audiovisual content in a storage memory MS. Optionally, it additionally cooperates with a module DISP for restoring a program guide EPG and a module for connection to a telecommunications network, for example of the Internet type, through which it exchanges with a service platform, and notably obtains the program guide EPG.

With reference to FIG. 7, the simplified structure of a device 200 for broadcasting a first data stream according to an example embodiment of the invention is now considered. The device 200 implements the broadcast method according to the invention as described above.

In this example, the device 200 is integrated with server equipment or a headend TR of an audiovisual data stream broadcast network RD. According to one variant, the device 200 could be independent and connected to the equipment TR.

For example, the device 200 comprises a processing unit 210, equipped for example with a processor P2, and driven by a computer program Pg₂ 220, stored in a memory 230 and implementing the broadcast method according to the invention.

Upon initialization, the code instructions of the computer program Pg₂ 220 are for example loaded into a RAM memory before being executed by the processor of the processing unit 210. The processor of the processing unit 210 implements the steps of the broadcast method described previously, according to the instructions of the computer program Pg₂ 220.

According to one embodiment of the invention, the device 200 comprises at least one unit INSERT for inserting an identifier of a second audiovisual content in the first data stream. These units are driven by the processor P2 of the processing unit 210.

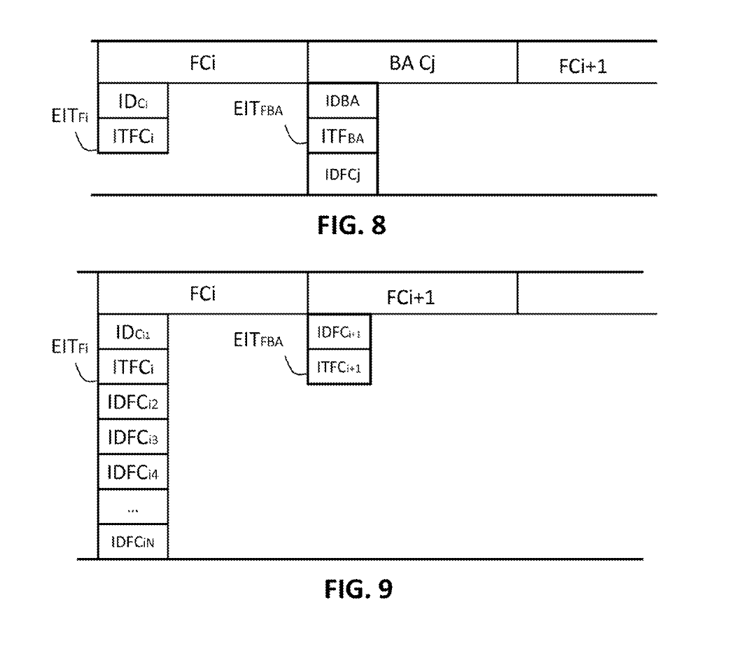

The invention which has just been described applies to various usage scenarios. A first usage scenario has been presented with reference to FIGS. 1 to 5. With reference to FIGS. 8 and 9, two other example applications will now be described in greater detail.

With reference to FIG. 8, it is considered that the first content being broadcast is a trailer BA for a second content, the broadcast of which is scheduled for a following day. Generally, according to the prior art, the signaling stream associated with the broadcast data stream does not transport a content identifier for this trailer, which is notably not intended to be displayed in the representation of the program guide restored to the user.

The invention therefore proposes to transmit a content identifier for this trailer, as if this were a case of conventional audiovisual content, and to use it in order to associate with it the identifier of the content which the trailer promotes.

In the example presented with reference to FIG. 8, the description element EIT_{FBA} contains the identifier ID_{BA} of the trailer and an identifier IDF of the film which the trailer promotes.

During the broadcast of this trailer BA, the user can, according to the invention, command an action on the associated film F by a simple push on a command key of his/her remote control.

As mentioned previously, the user can command the recording of the film F associated with the trailer BA. The user can also command the automatic zapping to the channel which broadcasts the film F as soon as the broadcast will have begun. Thus, if on the day of the broadcast of the film F, the user has selected a channel other than that which broadcasts the film F, the access terminal will immediately zap to the channel which broadcasts the film F, as soon as it starts; similarly, if the user switches on his/her television set late, while the broadcast of the film F has already begun, the access terminal will immediately zap to the channel broadcasting the film F.

With reference to FIG. 9, the case of a television series for which the N episodes of a season are broadcast each week at a determined time is now considered. The first content Ci₁ is for example the first episode of the series. At the end of this episode, a few images announce the next episode. According to this example embodiment of the invention, the description element EIT_{Fi1} of the first episode contains the identifiers of the next episodes Ci₂ to Ci_{N} of the season. Being thus associated with the broadcast of the first episode, the next episodes can be the subject of programming of actions by the user, while this first episode is being broadcast, insofar as the latter explicitly makes reference to the continuation of the season.

The invention thus allows the user to program in a simple manner, by a simple push of the “record” key of his/her remote control, the recording not only of the next announced episode Ci₂, but also of the set of episodes Ci₃ to Ci_{N} of the season. According to the invention, the user can, according to the same principle and just as simply, program the automatic zapping or any other planned action by his/her remote control, in connection with a future broadcast of these content items associated with the first episode Ci₁.

Of course other embodiments of the invention can be envisaged.

1. A method for processing a first data stream (Fi) broadcast via a broadcast network (RD) to an item of access equipment (STB) of a user and being restored by said access equipment, said first data stream encoding a first audiovisual content (Cᵢ) and containing at least one identifier (IDCᵢ) of said first audiovisual content, characterized in that, said first audiovisual content being associated with at least one second audiovisual content (Cⱼ), encoded in a second data stream (Fⱼ) which is planned to be broadcast, said method comprises the following steps:
detecting (T1), during the restoration of said first stream, of a user interaction representative of a command of predetermined action on said at least one second stream;
obtaining (T3) of an identifier (IDCⱼ) of said at least one second audiovisual content from the identifier of the first audiovisual content;
obtaining (T5) of time-related information (ITCⱼd, ITCⱼf) associated with said second content identifier;
programming (T7) of the commanded action at least with the aid of the second content identifier and the time-related information obtained, said action being intended to be triggered in connection with the broadcast of the second stream (Fⱼ).

2. The method for processing a first data stream as claimed in claim 1, characterized in that said identifier of the second content is obtained by looking up a description element (EDᵢ) of the first audiovisual content contained in a program guide (EPG), the identifier of the second audiovisual content being inserted in an information field of said element.

3. The method for processing a first data stream as claimed in claim 1, characterized in that the identifier of said at least one second content is obtained by looking up a description element (EITᵢ) of the first audiovisual content (Cᵢ) of an event information table (EIT) contained in the first broadcast stream (Fᵢ), said element containing the identifier of the second audiovisual content (IDCⱼ) in a first information field of said element.

4. The method for processing a first data stream broadcast via a broadcast network to an item of terminal equipment of a user and being restored on said terminal equipment, as claimed in claim 1, characterized in that said time-related information associated with the second content identifier is obtained by looking up the description element of the event information table contained in the first broadcast stream, said element containing said time-related information in a second information field of said element.

5. The method for processing a first data stream broadcast via a broadcast network to an item of terminal equipment of a user and being restored on said terminal equipment, as claimed in claim 1, characterized in that said time-related information is obtained by looking up a description element (EDⱼ) of the second stream contained in the program guide (EPG).

6. The method for processing a first data stream broadcast via a broadcast network to an item of terminal equipment of a user and being restored on said terminal equipment, as claimed in claim 5, characterized in that the lookup step is repeated at regular intervals until said information is found in the program guide.

7. A device (100) for processing a first audiovisual data stream broadcast via a broadcast network (RD) to an item of access equipment (STB) of a user and being restored by said access equipment, said first audiovisual data stream encoding a first audiovisual content and containing at least one identifier of said first audiovisual content, said first audiovisual content being associated with at least one second audiovisual content, encoded in a second audiovisual data stream which is planned to be broadcast, said device being characterized in that it comprises the following modules:
detecting (DET), during the restoration of said first stream, of a user interaction (UI) representative of a command of action on said at least one second stream;
obtaining (GET ID2) of an identifier of said at least one second associated audiovisual content, from an identifier of the first audiovisual content;
obtaining (GET IT) of time-related information associated with said second content identifier;
programming (PROG) of the commanded action at least with the aid of the second content identifier and the time-related information obtained, said action being intended to be triggered in connection with the broadcast of the second audiovisual stream.

8. An access terminal (STB) for accessing a broadcast network (RD) suitable for restoring audiovisual streams broadcast via said network, characterized in that it comprises a device (100) for processing a first audiovisual stream as claimed in claim 7.

9. A method for broadcasting a first audiovisual data stream (Fᵢ) intended to be broadcast via a broadcast network (RD) to an access terminal of a user and intended to be restored to said user by said terminal, said first stream (Fᵢ) encoding a first audiovisual content (Cᵢ) and containing at least one identifier (IDCᵢ) of said first audiovisual content, characterized in that it comprises a step (D1) for inserting in said first data stream an identifier (IDCⱼ) of at least one second audiovisual content (Cⱼ) associated with said first audiovisual content, said at least one second content being planned to be broadcast via the broadcast network (RD).

10. A device (200) for broadcasting a first audiovisual data stream (Fᵢ) via a broadcast network (RD) to an access terminal of a user, said first stream encoding a first audiovisual content (Cᵢ) and containing at least one identifier (IDCᵢ) of said first audiovisual content, characterized in that it comprises a module (INSERT) for inserting in said data stream an identifier (IDCⱼ) of a second audiovisual content associated with said first audiovisual content (Cⱼ), a second audiovisual data stream (Fⱼ) encoding said second content being planned to be broadcast via said network.

11. Server equipment (TR) suitable for broadcasting data streams over a broadcast network (RD), characterized in that it comprises a broadcast device (200) as claimed in claim 10.

12. A telecommunications signal carrying an audiovisual data stream intended to be broadcast via a broadcast network and restored to a user by an access terminal, said stream encoding a first audiovisual content and containing at least one identifier of said first audiovisual content, characterized in that said signal additionally contains an identifier of a second audiovisual content associated with said first audiovisual content, a second stream encoding said second content being planned to be broadcast, said identifier being implemented by a method for processing a first data stream (Fi) broadcast via a broadcast network (RD) to an item of access equipment (STB) of a user and being restored by said access equipment, said first data stream encoding a first audiovisual content (Cᵢ) and containing at least one identifier (IDCᵢ) of said first audiovisual content, characterized in that, said first audiovisual content being associated with at least one second audiovisual content (Cⱼ) encoded in a second data stream (Fⱼ) which is planned to be broadcast, said method comprises the following steps:
detecting (T1), during the restoration of said first stream, of a user interaction representative of a command of predetermined action on said at least one second stream;
obtaining (T3) of an identifier (IDCⱼ) of said at least one second audiovisual content from the identifier of the first audiovisual content;
obtaining (T5) of time-related information (ITCⱼd, ITCⱼf) associated with said second content identifier;
programming (T7) of the commanded action at least with the aid of the second content identifier and the time-related information obtained, said action being intended to be triggered in connection with the broadcast of the second stream (Fⱼ)
characterized in that said identifier of the second content is obtained by looking up a description element (EDᵢ) of the first audiovisual content contained in a program guide (EPG), the identifier of the second audiovisual content being inserted in an information field of said element and further characterized in that the identifier of said at least one second content is obtained by looking up a description element (EITᵢ) of the first audiovisual content (Cᵢ) of an event information table (EIT) contained in the first broadcast stream (Fᵢ), said element containing the identifier of the second audiovisual content (IDCⱼ) in a first information field of said element.

13. A system (SD) for broadcasting audiovisual data streams, characterized in that it comprises server equipment (TR) suitable for broadcasting data streams over a broadcast network (RD), characterized in that it comprises a broadcast device (200) for broadcasting a first audiovisual data stream (Fᵢ) via a broadcast network (RD) to an access terminal of a user, said first stream encoding a first audiovisual content (Cᵢ) and containing at least one identifier (IDCᵢ) of said first audiovisual content, characterized in that it comprises a module (INSERT) for inserting in said data stream an identifier (IDCⱼ) of a second audiovisual content associated with said first audiovisual content (Cⱼ), a second audiovisual data stream (Fⱼ) encoding said second content being planned to be broadcast via said network, at least one access terminal (STB) for accessing a broadcast network (RD) suitable for restoring audiovisual streams broadcast via said network, characterized in that it comprises a device (100) for processing a first audiovisual stream broadcast via a broadcast network (RD) to an item of access equipment (STB) of a user and being restored by said access equipment, said first audiovisual data stream encoding a first audiovisual content and containing at least one identifier of said first audiovisual content, said first audiovisual content being associated with at least one second audiovisual content, encoded in a second audiovisual data stream which is planned to be broadcast, said device being characterized in that it comprises the following modules:
detecting (DET), during the restoration of said first stream, of a user interaction (UI) representative of a command of action on said at least one second stream;
obtaining (GET ID2) of an identifier of said at least one second associated audiovisual content, from an identifier of the first audiovisual content;
obtaining (GET IT) of time-related information associated with said second content identifier;
programming (PROG) of the commanded action at least with the aid of the second content identifier and the time-related information obtained, said action being intended to be triggered in connection with the broadcast of the second audiovisual stream;
and a broadcast network (RD) suitable for broadcasting said streams between said server equipment and said at least one access terminal.

14. (canceled)

15. (canceled)
